(19) United States
(12) Patent Application Publication
(10) Pub. No.: US 2023/0350854 A1
(43) Pub. Date: Nov. 2, 2023

(54) INFORMATION PROCESSING SYSTEM AND ACCESS CONTROL METHOD

(71) Applicant: Fujitsu Limited, Kawasaki-shi (JP)

(72) Inventors: ERIKA HAYASHI, Yokohama (JP); HIROKI OHTSUJI, Yokohama (JP)

(73) Assignee: Fujitsu Limited, Kawasaki-shi (JP)

(21) Appl. No.: 18/155,779

(22) Filed: Jan. 18, 2023

(30) Foreign Application Priority Data
Mar. 29, 2022 (JP) 2022-053107

(51) Int. Cl. G06F 16/178; G06F 16/172; G06F 16/188

(52) U.S. Cl. CPC G06F 16/178; G06F 16/172; G06F 16/188

(57) ABSTRACT

An information processing system including a first file system, a synchronization agent, an intercept library and a virtual file system and when a first access request for a first file is received in advance, the first file system transmits a first file path for the first file to the synchronization agent, the intercept library transmits a second file path for a second file to the synchronization agent, and the synchronization agent determines whether the second file path is stored and performs control such that an access to the second file is performed by the first file system via the virtual file system when determining that the second file path is stored, and performs control such that the access to the second file is performed by the intercept library via the second file system when determining that the second file path is not stored.

### CROSS-REFERENCE TO RELATED APPLICATION

This application is based upon and claims the benefit of priority of the prior Japanese Patent Application No. 2022-53107, filed on Mar. 29, 2022, the entire contents of which are incorporated herein by reference.

### FIELD

The embodiments discussed herein are related to an information processing system and an access control method.

### BACKGROUND

In recent years, in the field of a distributed file system, for example, a file system that may be implemented in a memory space (hereinafter, also referred to as a user space) in which an application operates has appeared. For example, in this case, a developer implements the file system in the user space by using, for example, a filesystem in user space (FUSE). Accordingly, the developer may easily implement the file system, for example, as compared with a case where the file system is implemented in a memory space (hereinafter, also referred to as a kernel space) in which a kernel operates.

U.S. Pat. No. 8145614 is disclosed as related art.

### SUMMARY

According to an aspect of the embodiments, an information processing system including: a memory configured to store a file; and a processor including a first file system, a synchronization agent, an intercept library implemented in a user space and a virtual file system implemented in a kernel space and configured to control an access to the file stored in the memory. In a case where a first access request for a first file stored in the memory is received in advance, the first file system transmits a first file path for the first file to the synchronization agent, the synchronization agent stores the first file path received from the first file system in a first memory, the intercept library transmits, in response to hooking a second access request for a second file stored in the memory this time, a second file path for the second file to the synchronization agent, and the synchronization agent determines whether the second file path is stored in the first memory, in response to reception of the second file path transmitted from the intercept library, and performs control such that an access to the second file is performed by the first file system via the virtual file system in a case where it is determined that the second file path is stored in the first memory, and performs control such that the access to the second file is performed by the intercept library not via the virtual file system but via the second file system in a case where it is determined that the second file path is not stored in the first memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of an information processing system;

FIG. 2 is a diagram illustrating a hardware configuration of an information processing apparatus;

FIG. 3 is a diagram illustrating functionalities of the information processing apparatus in a comparative example;

FIG. 4 is a diagram illustrating functionalities of the information processing apparatus in the comparative example;

FIG. 5 is a diagram illustrating functionalities of the information processing apparatus in the comparative example;

FIG. 6 is a diagram illustrating functionalities of the information processing apparatus in the comparative example;

FIG. 7 is a diagram illustrating functionalities of the information processing apparatus in the comparative example;

FIG. 8 is a diagram illustrating functionalities of the information processing apparatus in the comparative example;

FIG. 9 is a diagram illustrating functionalities of an information processing apparatus in a first embodiment;

FIG. 10 is a flowchart illustrating access control processing in the first embodiment;

FIG. 11 is a flowchart illustrating the access control processing in the first embodiment;

FIG. 12 is a flowchart illustrating the access control processing in the first embodiment;

FIG. 13 is a flowchart illustrating the access control processing in the first embodiment;

FIG. 14 is a diagram illustrating the access control processing in the first embodiment;

FIG. 15 is a diagram illustrating the access control processing in the first embodiment;

FIG. 16 is a diagram illustrating the access control processing in the first embodiment;

FIG. 17 is a diagram illustrating the access control processing in the first embodiment;

FIG. 18 is a flowchart illustrating access control processing in a second embodiment;

FIG. 19 is a flowchart illustrating the access control processing in the second embodiment;

FIG. 20 is a flowchart illustrating the access control processing in the second embodiment;

FIG. 21 is a flowchart illustrating the access control processing in the second embodiment;

FIG. 22 is a diagram illustrating the access control processing in the second embodiment;

FIG. 23 is a diagram illustrating the access control processing in the second embodiment;

FIG. 24 is a flowchart illustrating access control processing in a third embodiment;

FIG. 25 is a flowchart illustrating the access control processing in the third embodiment; and

FIG. 26 is a flowchart illustrating the access control processing in the third embodiment.

### DESCRIPTION OF EMBODIMENTS

An access request (an operation on the file system) to a file managed by the file system as described above is made by calling a functionality of a kernel as a function. For this reason, in a case where the file system is implemented in the user space, when transmission and reception of the access request to the file are performed, switching occurs between the user space and the kernel space. Hereinafter, a route of the access request involving switching between the user space and the kernel space is also referred to as a first route.

In this regard, for example, there is a case where a developer implements the file system such that transmission and reception of the access request to the file are performed without involving switching between the user space and the kernel space by hooking and executing a call of a function to the kernel in the user space. Accordingly, for example, the developer may perform an access to the file at a higher speed than in a case where the access request passes through the first route. Hereinafter, a route of an access request that does not involve switching between the user space and the kernel space is also referred to as a second route.

For example, in a case where a file accessed by an access request passing through the first route is stored in a cache disposed on the first route, the file stored in the cache is not referred to when an access request passing through the second route is performed. For this reason, there is a possibility that consistency of an access result to the file as described above is not maintained between the case where of passing through the first route and the case of passing through the second route.

Therefore, in one aspect, an object of the present disclosure is to provide an information processing system and an access control method that are capable of maintaining the consistency of the access result to the file.

### Configuration of Information Processing System in First Embodiment

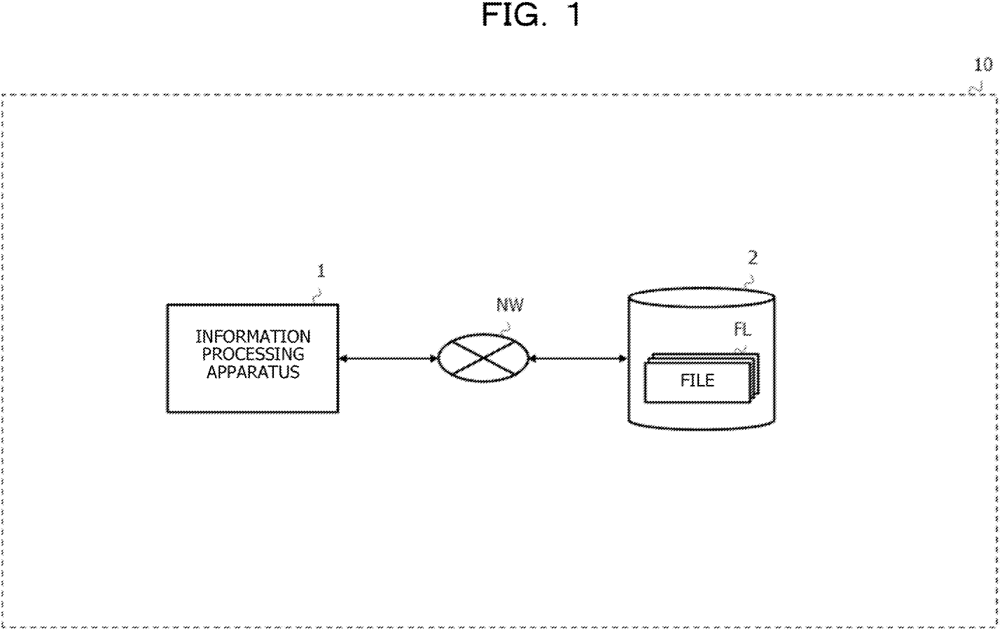

First, a configuration of an information processing system 10 is described. FIG. 1 is a diagram illustrating a configuration of the information processing system 10.

The information processing system 10 illustrated in FIG. 1 includes, for example, an information processing apparatus 1 and a storage apparatus 2.

The information processing apparatus 1 is, for example, a physical machine or a virtual machine, and an application for providing various services to a user operates on the information processing apparatus 1, for example. For example, a file system that manages a file stored in the storage apparatus 2 in the user space is implemented in the information processing apparatus 1, for example. For example, in a case where an access request for the file (file stored in the storage apparatus 2) managed by the file system is issued from the application, the information processing apparatus 1 performs processing (hereinafter, also referred to as access control processing) of controlling a route through which transmission and reception of the issued access request are performed.

For example, the storage apparatus 2 is an apparatus equipped with a hard disk drive (HDD) or a solid-state drive (SSD), and stores a file referred to by the information processing apparatus 1 (application).

For example, the information processing system 10 may further include an operation terminal (not illustrated) such as a personal computer (PC) with which a user inputs and browses desired information.

### Hardware Configuration of Information Processing Apparatus

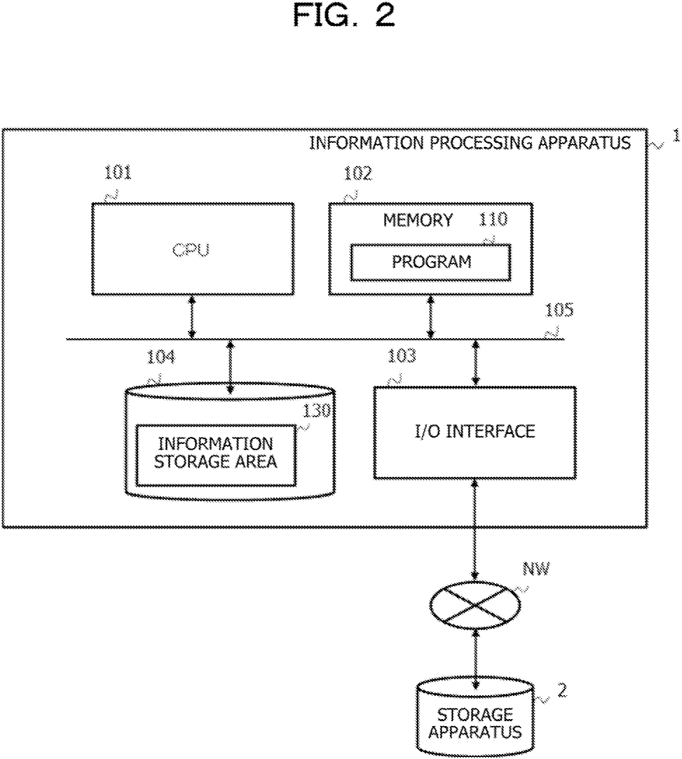

Next, a hardware configuration of the information processing apparatus 1 is described. FIG. 2 is a diagram illustrating a hardware configuration of the information processing apparatus 1.

As illustrated in FIG. 2, the information processing apparatus 1 includes a central processing unit (CPU) 101, which is a processor, a memory 102, a communication apparatus 103, and a storage medium 104. The CPU 101, the memory 102, the communication apparatus 103, and the storage medium 104 are coupled to each other via a bus 105.

For example, the storage medium 104 has a program storage area (not illustrated) for storing a program 110 for performing the access control processing. For example, the storage medium 104 has an information storage area 130 that stores information used when the access control processing is performed. The storage medium 104 may be, for example, an HDD or an SSD.

For example, the CPU 101 executes the program 110 loaded from the storage medium 104 to the memory 102 to perform the access control processing.

For example, the communication apparatus 103 communicates with the storage apparatus 2.

### Functionalities of Information Processing Apparatus in Comparative Example

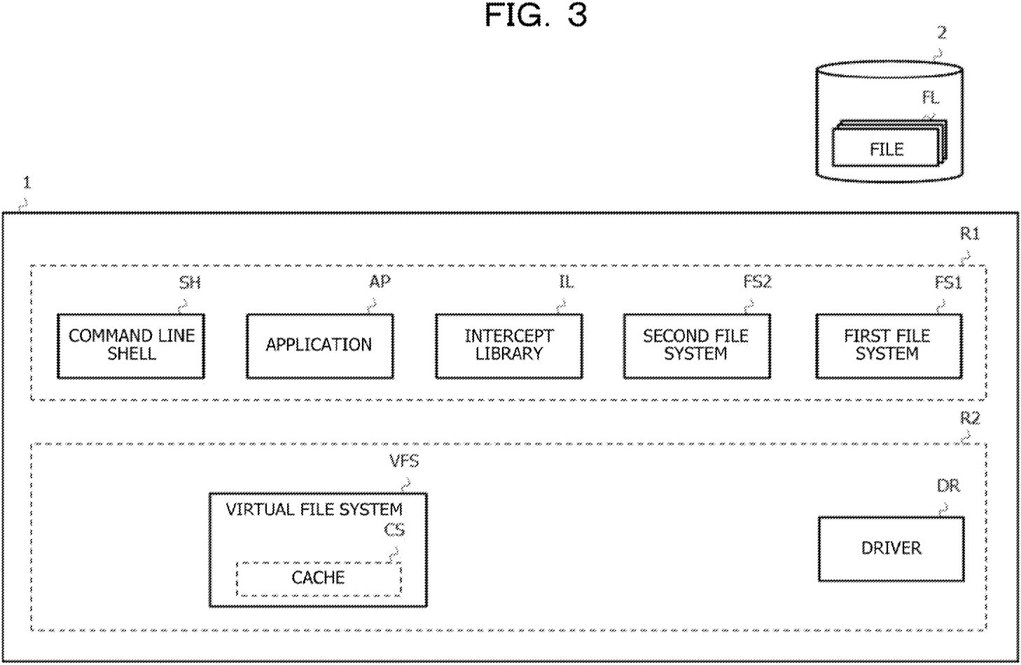

Next, functionalities of the information processing apparatus 1 in a comparative example are described. FIGS. 3 to 8 are diagrams illustrating functionalities of the information processing apparatus 1 in the comparative example.

As illustrated in FIG. 3, in the information processing apparatus 1, for example, the hardware such as the CPU 101 and the memory 102 and the program 110 organically cooperate with each other, so that various functionalities including an application AP, an intercept library IL, a first file system FS1, a second file system FS2, and a command line shell SH are implemented as functions in a user space R1.

As illustrated in FIG. 3, in the information processing apparatus 1, for example, the hardware such as the CPU 101 and the memory 102 and the program 110 organically cooperate with each other, so that various functionalities including a virtual file system VFS and a driver DR are implemented as functionalities in a kernel space R2.

Although a case where each of the first file system FS1 and the second file system FS2 operates in the information processing apparatus 1 is described below, the embodiment is not limited thereto. For example, a single file system having both the functionality of the first file system FS1 and the functionality of the second file system FS2 may operate in the information processing apparatus 1.

For example, the application AP executes processing for providing various services to the user. For example, when a demand to access a file FL stored in the storage apparatus 2 arises along with the execution of the processing, the application AP issues an access request to the virtual file system VFS.

For example, the virtual file system VFS is a functionality that enables transparent access to the file FL stored in the storage apparatus 2 by abstracting the first file system FS1. For example, when the access request issued by the application AP is received, the virtual file system VFS stores the received access request in a queue (not illustrated) in the driver DR, for example.

For example, the driver DR sequentially transmits, to the first file system FS1, the access requests (access requests stored in the queue) transmitted from the virtual file system VFS.

For example, the first file system FS1 performs an access (access to the file FL stored in the storage apparatus 2) corresponding to the access request transmitted from the driver DR. For example, the first file system FS1 executes a function corresponding to an access request included in the access requests transmitted from the driver DR among functions stored in a library (not illustrated) of the kernel.

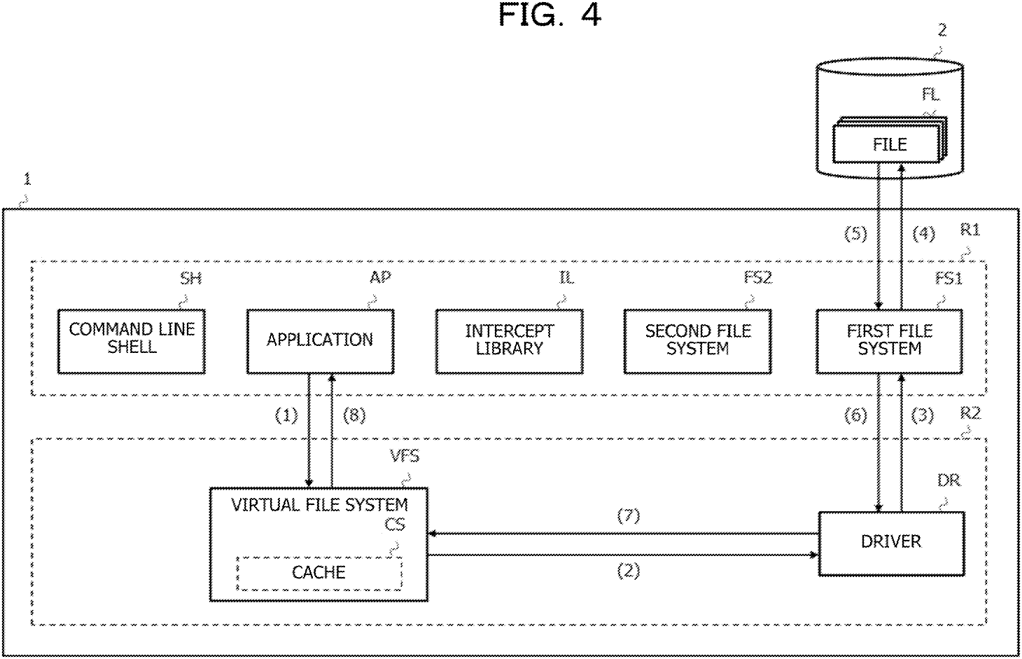

For example, in a case where an access request for the file FL managed by the first file system FS1 is issued from the application AP, there is a case where transmission and reception of the access request are performed in the information processing apparatus 1 via a route (first route) passing through the virtual file system VFS, the driver DR, and the first file system FS1, for example, as indicated by (1) to (4) in FIG. 4. Thereafter, in this case, in the information processing apparatus 1, as indicated by (5) to (8) in FIG. 2, for example, transmission and reception of the result of executing the access request are performed via a route passing through the first file system FS1, the driver DR, and the virtual file system VFS.

For example, the intercept library IL hooks the access request issued from the application AP to the first file system FS1. For example, the intercept library IL transmits the hooked access request to the second file system FS2.

For example, the second file system FS2 performs an access (access to the file FL stored in the storage apparatus 2) with respect to the access request transmitted from the intercept library IL. For example, the second file system FS2 executes a function corresponding to an access request included in the access request transmitted from the driver DR among the functions stored in the intercept library IL.

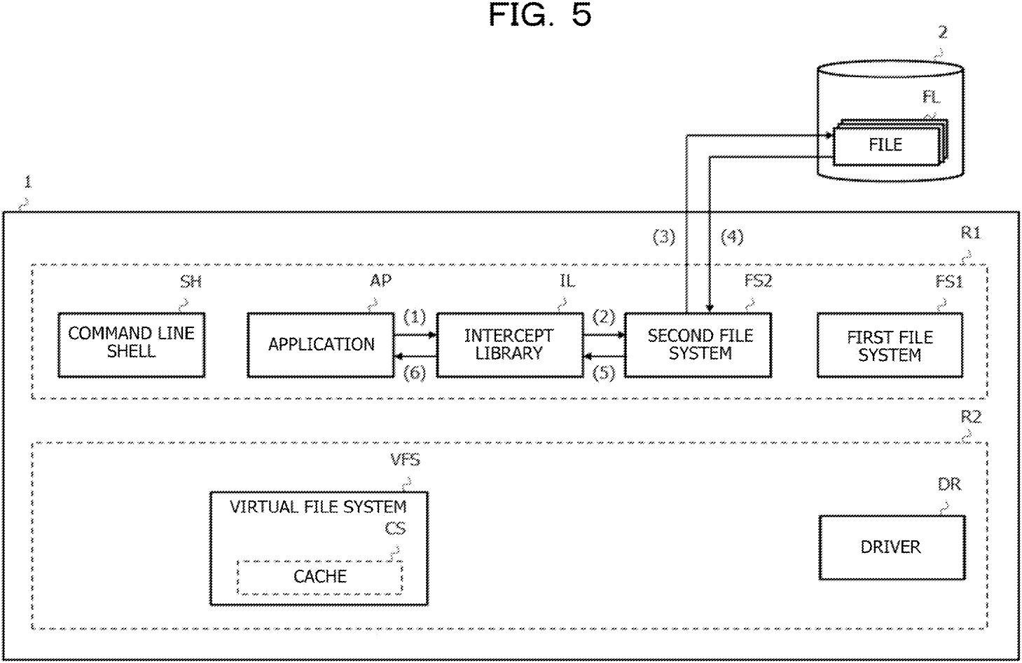

For example, in a case where an access request for the file FL managed by the first file system FS1 is issued from the application AP, there is a case where transmission and reception of the access request via a route (second route) passing through the intercept library IL and the second file system FS2 are performed in the information processing apparatus 1, for example, as indicated by (1) to (3) in FIG. 5. Thereafter, in this case, in the information processing apparatus 1, as indicated by (4) to (6) in FIG. 5, for example, transmission and reception of the result of executing the access request are performed via a route passing through the second file system FS2 and the intercept library IL.

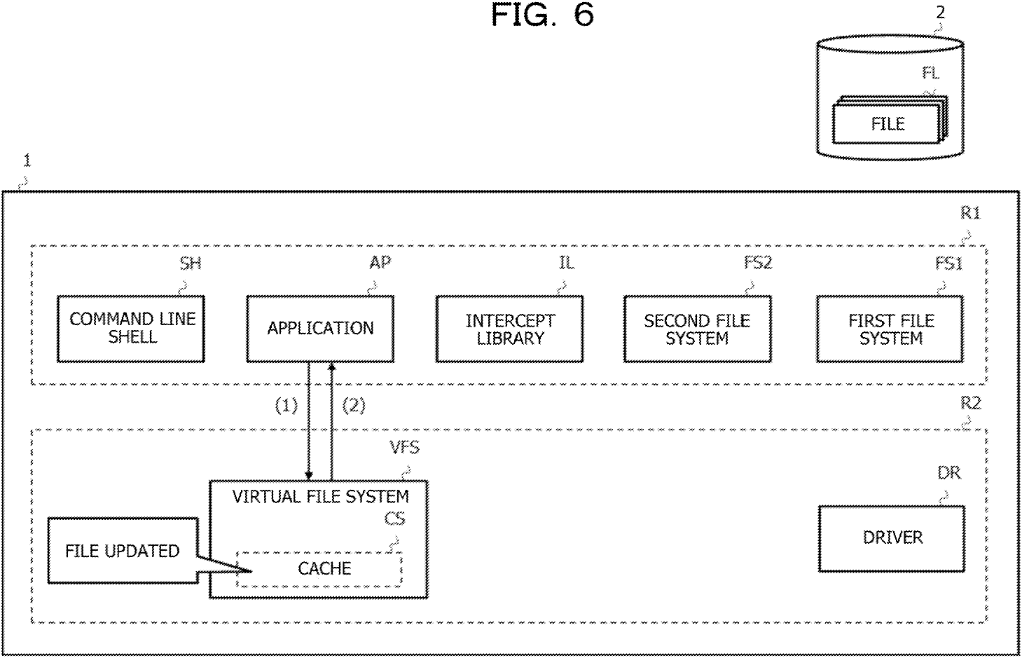

The virtual file system VFS includes, for example, a cache CS that stores the file FL read from the storage apparatus 2. For example, when an access to the file FL stored in the storage apparatus 2 is performed, the virtual file system VFS stores the access-target file FL in the cache CS. For example, when an access to the same file FL is performed next time or later, the virtual file system VFS performs an access to the file FL stored in the cache CS without transmitting an access request to the first file system FS1 as indicated by (1) and (2) in FIG. 6.

Accordingly, for example, even in a case where transmission and reception of an access request passing through the first route are performed in the information processing apparatus 1, since switching between the user space R1 and the kernel space R2 is no longer to be performed, an access to the file FL to be accessed may be performed at a higher speed.

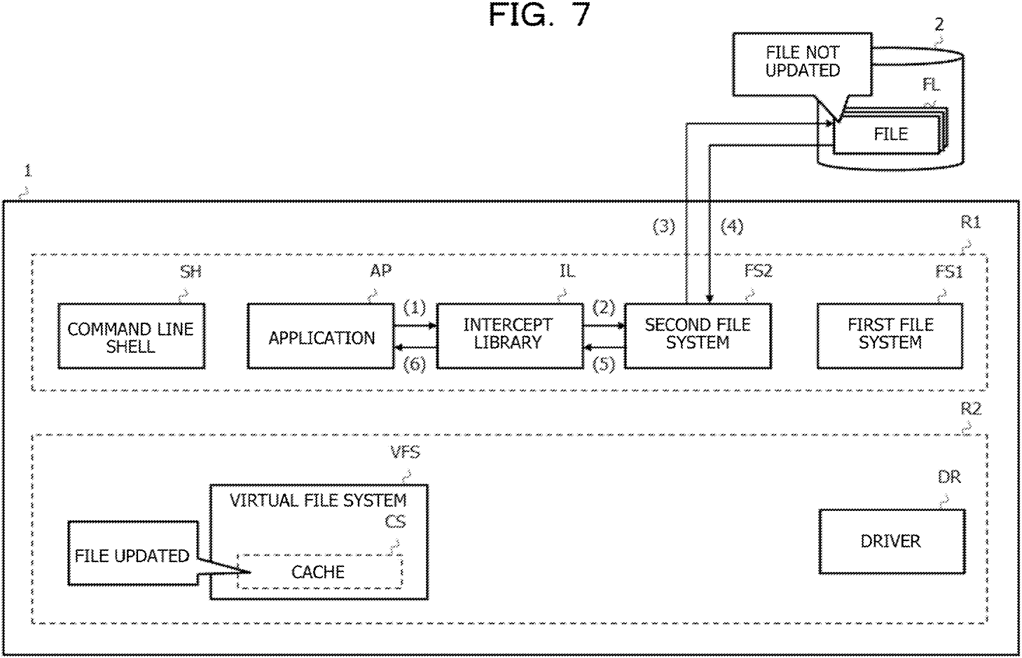

However, in a case where transmission and reception of the access request passing through the second route are performed, the file FL stored in the cache CS is not referred to when transmission and reception of the access request passing through the second route are performed, as indicated by (1) to (8) in FIG. 7. For this reason, as illustrated in FIG. 7, for example, in a case where there is a difference between the file FL stored in the cache CS and the file FL stored in the storage apparatus 2, there is a possibility that the application AP refers to the file FL before the file FL stored in the cache CS is written back. Accordingly, there is a possibility that the access result to the file FL is not maintained to be consistent between the case of passing through the first route and the case of passing through the second route.

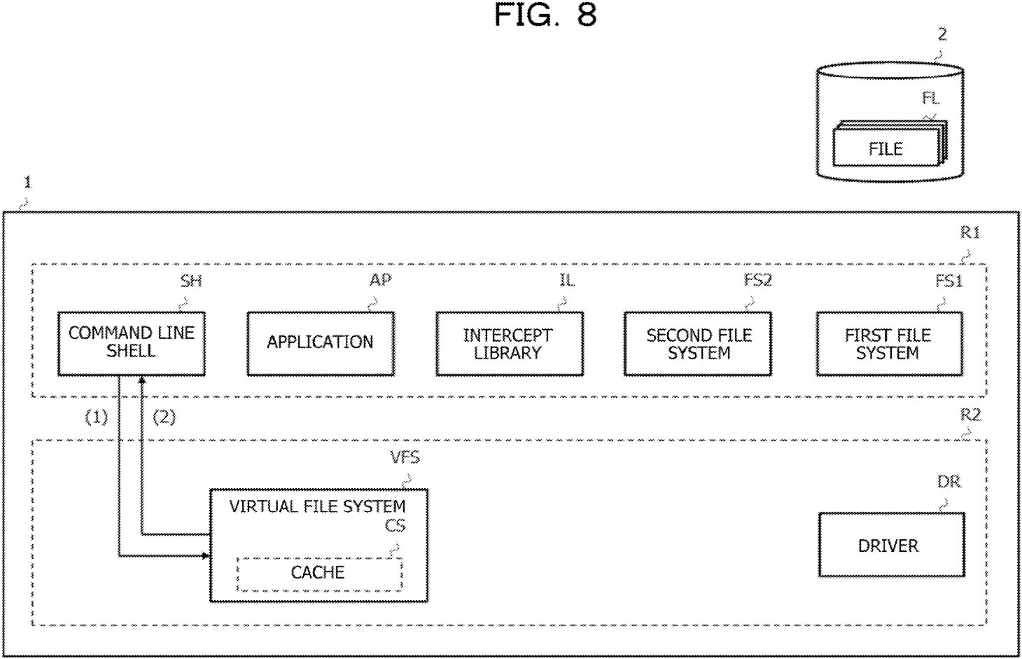

For example, when the user inputs a command from an operation terminal (not illustrated) or the like, the command line shell SH performs an access to the file FL stored in the cache CS as indicated by (1) and (2) in FIG. 8. For this reason, also in this case, there is a possibility that the access result to the file FL is not maintained to be consistent with the case of passing through the second route.

Accordingly, in a case where an access request (hereinafter, also referred to as a first access request) for a file FL (hereinafter, also referred to as a first file FL) stored in the storage apparatus 2 is received from the application AP, for example, the first file system FS1 in the present embodiment transmits a file path (hereinafter, also referred to as a first file path) for the first file FL to a synchronization agent. The first access request is a past (previous) access request made before a second access request to be described later.

For example, the synchronization agent in the present embodiment stores the first file path received from the first file system FS1 in a storage unit (hereinafter, also referred to as a first storage unit). For example, the first storage unit is a partial area of the information storage area 130.

For example, in response to hooking of an access request (hereinafter, also referred to as a second access request) from the application AP to a file FL (hereinafter, also referred to as a second file FL) stored in the storage apparatus 2, the intercept library IL in the present embodiment transmits a second file path for the second file FL to the synchronization agent. The second access request is a current (actual) access request made after the first access request described above.

Thereafter, for example, in response to the reception of the second file path transmitted from the intercept library IL, the synchronization agent in the present embodiment determines whether the second file path is stored in the first storage unit. As a result, when it is determined that the second file path is stored in the first storage unit, the synchronization agent performs control such that an access to the second file FL is performed by the first file system FS1, for example. For example, in this case, the synchronization agent performs control such that transmission and reception of the second access request are performed through the first route (via the virtual file system VFS), for example. In a case where it is determined that the second file path is not stored in the first storage unit, the synchronization agent performs control such that the access to the second file FL is performed by the intercept library IL, for example. For example, in this case, the synchronization agent performs control such that the transmission and reception of the second access request are performed through the second route (via the second file system FS2 not via the virtual file system VFS or the first file system FS1), for example.

For example, in a case where the second access request issued by the application AP is hooked, the intercept library IL in the present embodiment makes an inquiry about whether a file path of the file FL to be accessed by the second access request has been stored, to the synchronization agent that stores the file path for the file FL accessed through the first route in the past. For example, in a case where the file path corresponding to the second access request has been stored by the synchronization agent, the intercept library IL determines that the file FL to be accessed by the second access request is the file FL that has been accessed through the first route in the past, and performs control such that transmission and reception of the second access request are performed through the first route.

Accordingly, for example, the information processing apparatus 1 in the present embodiment may suppress the access request for the same file FL from being performed through both the first route and the second route. For this reason, for example, the information processing apparatus 1 may maintain consistency of the access result to the file FL.

### Functionalities of Information Processing Apparatus in First Embodiment

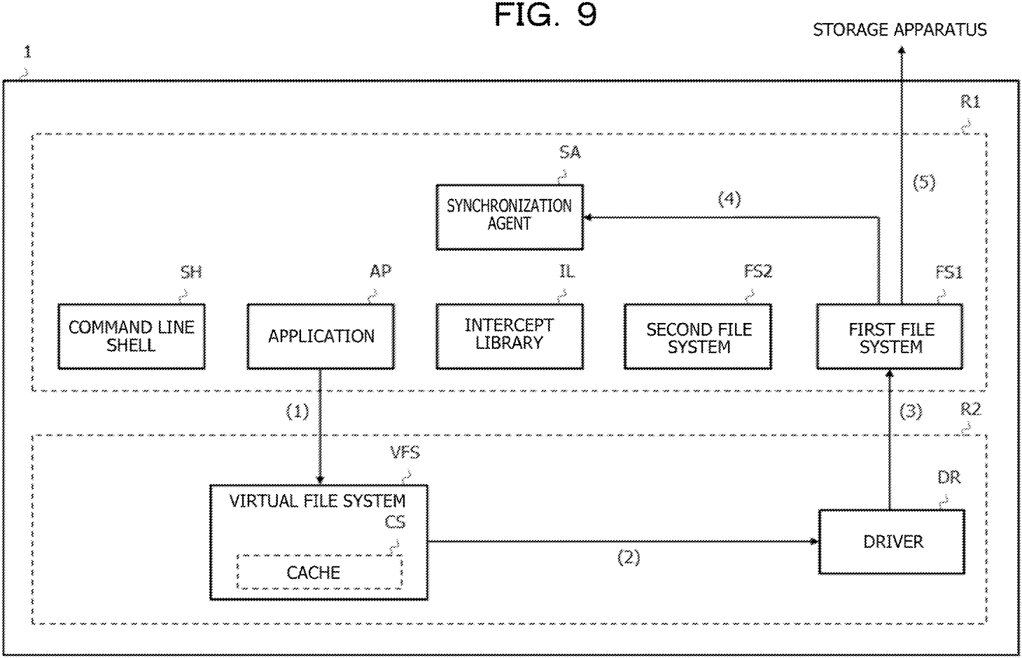

Next, functionalities of the information processing apparatus 1 in the first embodiment are described. FIG. 9 is a diagram illustrating functionalities of the information processing apparatus 1 in the first embodiment. Differences from the functionalities of the information processing apparatus 1 in the comparative example described with reference to FIG. 3 and the like are described below.

As illustrated in FIG. 9, in the information processing apparatus 1, for example, the hardware such as the CPU 101 and the memory 102 and the program 110 organically cooperate with each other, so that various functionalities including a synchronization agent SA are implemented as functionalities in the user space R1.

For example, in a case where a first file path is received from the first file system FS1, the synchronization agent SA stores information (hereinafter, also referred to as file path information 131) indicating the received first file path in the information storage area 130.

For example, in a case where a second file path transmitted from the intercept library IL is received, the synchronization agent SA determines whether the received second file path is stored in the information storage area 130 as the file path information 131. As a result, when it is determined that the second file path is stored, the synchronization agent SA performs control such that, for example, an access to the second file FL corresponding to the second access request is performed by the first file system FS1. In a case where it is determined that the second file path is not stored, the synchronization agent SA performs control such that, for example, the access to the second file FL corresponding to the second access request is performed by the intercept library IL (second file system FS2).

### Access Control Processing in First Embodiment

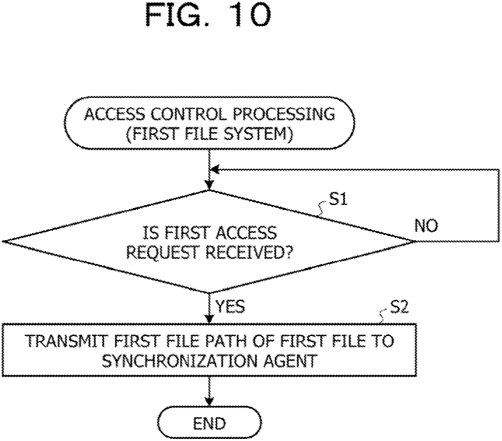

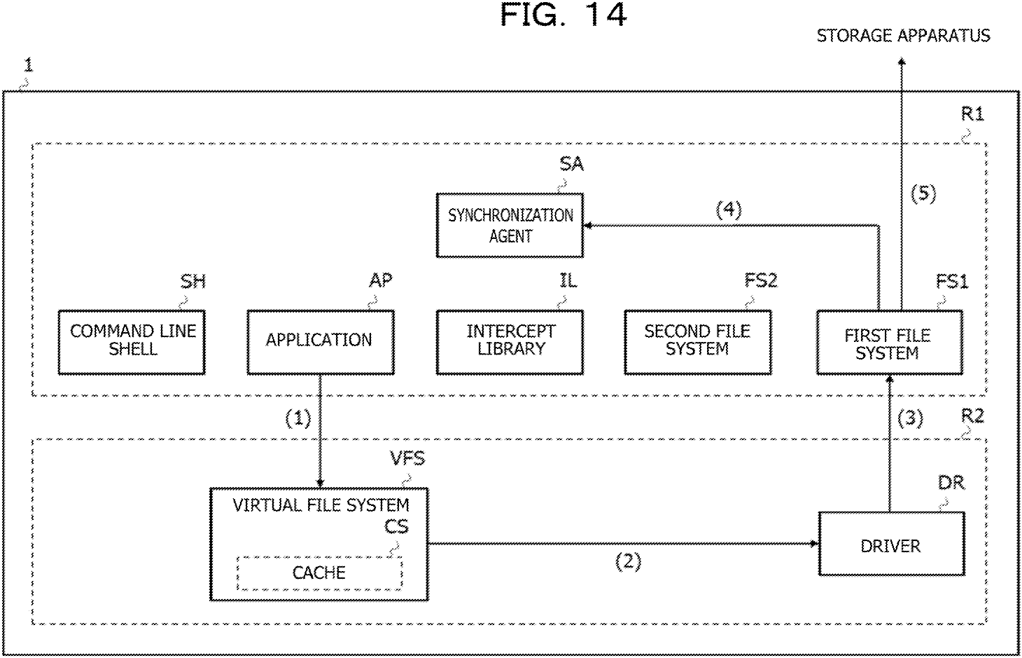

Next, the access control processing in the first embodiment is described. FIGS. 10 to 13 are flowcharts illustrating the access control processing in the first embodiment. FIGS. 14 to 17 are diagrams illustrating the access control processing in the first embodiment.

As illustrated in FIG. 10, for example, the first file system FS1 waits until a first access request for the first file FL stored in the storage apparatus 2 is received (NO in S1). For example, the first file system FS1 waits until the access request issued by the application AP is transmitted via a route (first route) including the virtual file system VFS and the driver DR.

For example, when the first access request for the first file FL stored in the storage apparatus 2 is received (YES in S1), the first file system FS1 transmits a first file path of the first file FL corresponding to the received first access request to the synchronization agent SA (S2).

For example, as indicated by (1) to (5) in FIG. 14, for example, in a case where the first access request issued by the application AP is received, the first file system FS1 accesses the first file FL stored in the storage apparatus 2 and transmits the first file path of the first file FL to the synchronization agent SA.

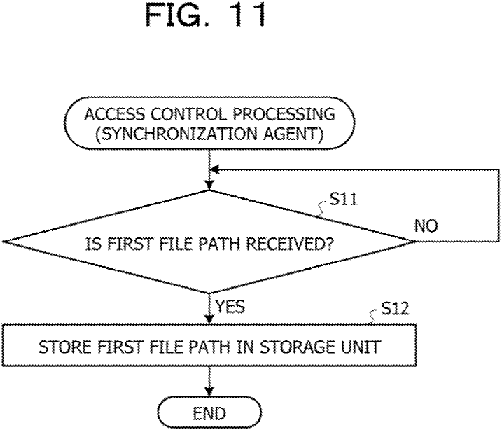

On the other hand, as illustrated in FIG. 11, for example, the synchronization agent SA waits until the first file path transmitted from the first file system FS1 is received (NO in S11).

For example, in a case where the first file path transmitted from the first file system FS1 is received (YES in S11), the synchronization agent SA stores the file path information 131 indicating the received first file path in the information storage area 130 (S12).

Accordingly, the synchronization agent SA may accumulate, for example, the file path information 131 indicating the file path of the file FL (file FL accessed by the access request through the first route) accessed by the first file system FS1. Hereinafter, a specific example of the file path information 131 is described.

### Specific Example of File Path Information

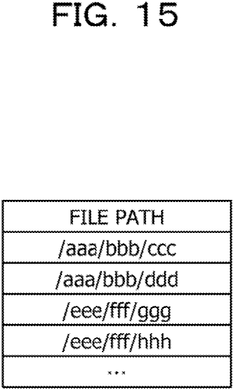

FIG. 15 is a diagram illustrating a specific example of the file path information 131.

For example, in the file path information 131 illustrated in FIG. 15, “/aaa/bbb/ccc”, “/aaa/bbb/ddd”, “/eee/fff/ggg”, and “/eee/fff/hhh” are set as the “file path”.

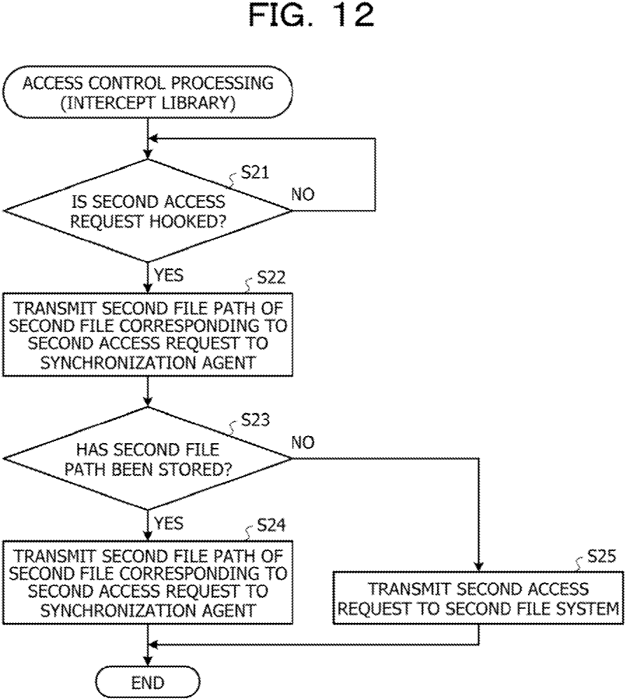

Returning to FIG. 12, for example, the intercept library IL waits until the second access request for the second file FL stored in the storage apparatus 2 is hooked (NO in S21).

For example, when the second access request for the second file FL stored in the storage apparatus 2 is received (YES in S21), the second file system FS2 transmits the second file path of the second file FL corresponding to the received second access request to the synchronization agent SA (S22).

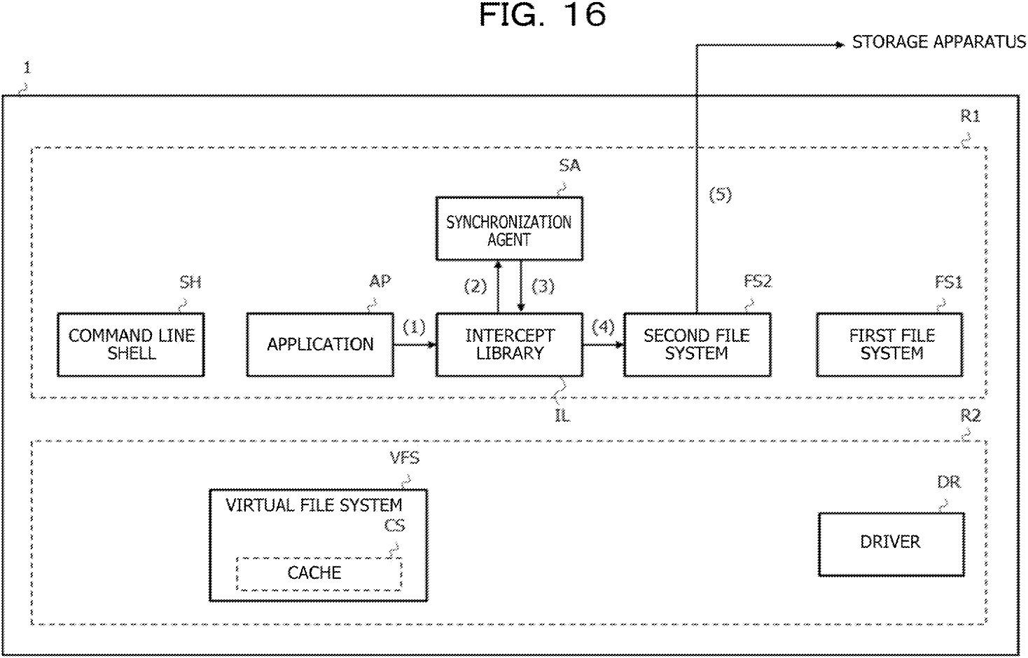

For example, when the intercept library IL hooks the second access request as indicated by (1) in FIG. 16, for example, the intercept library IL inquires of the synchronization agent SA whether the second file path of the second file FL corresponding to the hooked second access request is accumulated as the file path information 131, as indicated by (2) in FIG. 16.

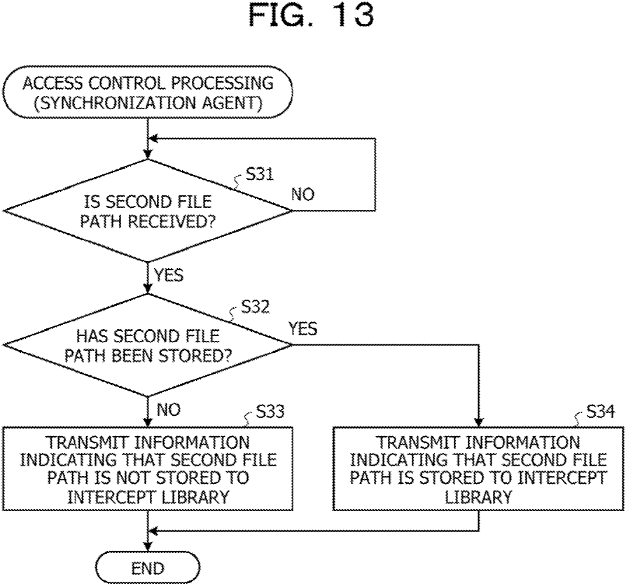

On the other hand, as illustrated in FIG. 13, for example, the synchronization agent SA waits until the second file path transmitted from the intercept library IL is received (NO in S31). For example, in a case where the second file path transmitted from the second file system FS2 is received (YES in S31), the synchronization agent SA determines whether the received second file path is stored in the information storage area 130 as the file path information 131 (S32).

As a result, when it is determined that the second file path is not stored (NO in S32), the synchronization agent SA performs control such that, for example, an access to the second file FL corresponding to the second access request is performed by the intercept library IL (second file system FS2) (S33). For example, in this case, as indicated by (3) in FIG. 16, the synchronization agent SA transmits information indicating that the second file path is not stored in the information storage area 130 as the file path information 131 to the intercept library IL. For example, in this case, the synchronization agent SA instructs the intercept library IL to transmit the second access request hooked by the intercept library IL to the second file system FS2, for example.

For example, in this case, as indicated by (4) and (5) in FIG. 16, the synchronization agent SA performs control such that, for example, transmission and reception of the second access request are performed through the second route.

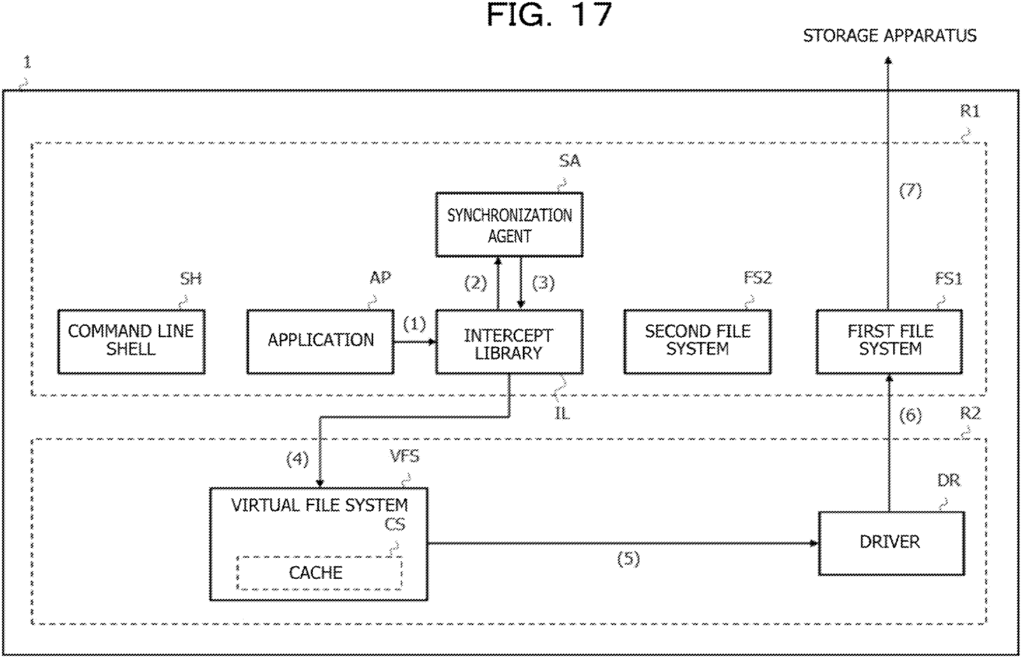

By contrast, when it is determined that the second file path is stored (YES in S32), the synchronization agent SA performs control such that the access to the second file FL corresponding to the second access request is performed by the first file system FS1, for example (S34). For example, in this case, as indicated by (3) in FIG. 17, the synchronization agent SA transmits information indicating that the second file path is stored in the information storage area 130 as the file path information 131 to the intercept library IL. For example, in this case, the synchronization agent SA instructs the intercept library IL to transmit the second access request hooked by the intercept library IL to the first file system FS1.

For example, in this case, as indicated by (4) to (7) in FIG. 17, the synchronization agent SA performs control such that, for example, the transmission and reception of the second access request are performed through the first route.

Returning to FIG. 12, for example, when the information indicating that the second file path is stored in the information storage area 130 as the file path information 131 is received from the synchronization agent SA (YES in S23), the intercept library IL transmits, for example, the hooked second access request to the first file system FS1 (S24). For example, the intercept library IL transmits the second access request to the virtual file system VFS.

For example, in this case, the intercept library IL determines that the second file FL corresponding to the hooked second access request is a file FL accessed through the first route in the past, for example. For this reason, in this case, the intercept library IL performs control such that the access to the second file FL is performed through the first route also in this time, for example.

By contrast, for example, when the information indicating that the second file path is not stored in the information storage area 130 as the file path information 131 is received from the synchronization agent SA (NO in S23), the intercept library IL transmits the hooked second access request to the second file system FS2 (S25).

For example, in this case, the intercept library IL determines that the second file FL corresponding to the hooked second access request is a file FL that has not been accessed through the first route in the past, for example. For this reason, in this case, the intercept library IL performs control such that the access to the second file FL is performed through the second route, for example.

As described above, for example, in a case where the first access request for the first file FL stored in the storage apparatus 2 is received, the first file system FS1 in the present embodiment transmits a first file path for the first file FL to the synchronization agent SA.

For example, the synchronization agent SA in the present embodiment stores the first file path received from the first file system FS1 in the information storage area 130.

For example, in response to the hooking of the second access request for the second file FL stored in the storage apparatus 2, the intercept library IL in the present embodiment transmits a second file path for the second file FL to the synchronization agent SA.

Thereafter, in response to the reception of the second file path transmitted from the intercept library IL, for example, the synchronization agent SA in the present embodiment determines whether the second file path is stored in the information storage area 130. As a result, when it is determined that the second file path is stored in the information storage area 130, the synchronization agent SA performs control such that the first file system FS1 performs an access to the second file FL, for example. In a case where it is determined that the second file path is not stored in the information storage area 130, the synchronization agent SA performs control such that the intercept library IL performs the access to the second file FL, for example.

For example, in a case where the second access request issued by the application AP is hooked, the intercept library IL in the present embodiment makes an inquiry about whether a file path of the file FL to be accessed by the second access request has been stored, to the synchronization agent SA that stores the file path for the file FL accessed through the first route in the past. For example, in a case where it is determined that the file path corresponding to the second access request has been stored in the synchronization agent SA, the intercept library IL determines that the file FL to be accessed by the second access request is the file FL accessed through the first route in the past, and performs control such that transmission and reception of the second access request are continuously performed through the first route.

Accordingly, for example, the information processing apparatus 1 in the present embodiment may suppress the access request for the same file FL from being performed through both the first route and the second route. For example, the information processing apparatus 1 may suppress an access to the file FL stored in the cache CS from being performed through the second route. For this reason, for example, the information processing apparatus 1 may maintain consistency of the access result to the file FL.

### Access Control Processing in Second Embodiment

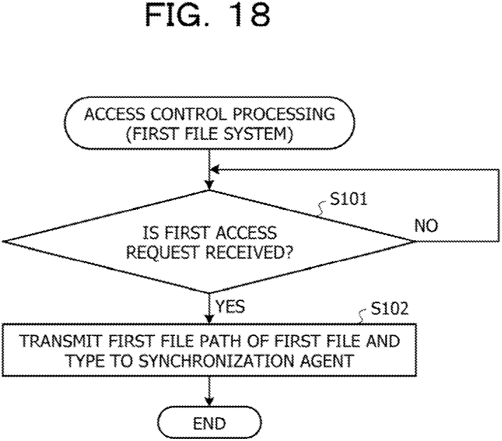

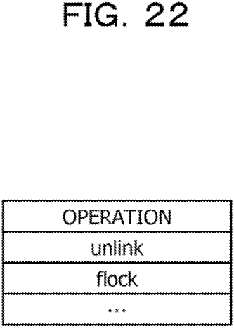

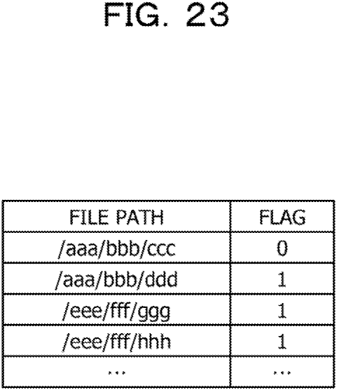

Next, access control processing in a second embodiment is described. FIGS. 18 to 21 are flowcharts illustrating the access control processing in the second embodiment. FIGS. 22 and 23 are diagrams illustrating the access control processing in the second embodiment.

There is a case where an access request for the file FL issued by the application AP includes an access request (hereinafter, also referred to as a specific access request) for which the target file FL is not stored in the cache CS even when transmission and reception are performed through the first route.

Accordingly, in the access control processing in the second embodiment, even when the second file path of the second file FL corresponding to the second access request hooked by the intercept library IL is stored in the synchronization agent SA, in a case where the access request corresponding to the second access request is the specific access request, transmission and reception of the access request are performed through the second route. For example, in the access control processing in the second embodiment, in this case, the transmission and reception of the second access request are performed through the second route without changing the route through which the second access request is transmitted and received to the first route.

Accordingly, for example, the information processing apparatus 1 may increase a frequency with which the transmission and reception of the second access request are performed through the second route. For this reason, the information processing apparatus 1 may increase a frequency of the second access request for which the transmission and reception are performed at a higher speed, for example.

As illustrated in FIG. 18, for example, the first file system FS1 waits until the first access request for the first file FL stored in the storage apparatus 2 is received (NO in S101).

For example, when the first access request for the first file FL stored in the storage apparatus 2 is received (YES in S101), the first file system FS1 transmits a first file path of the first file FL corresponding to the received first access request and a type (hereinafter, also referred to as a first type) of the access request corresponding to the received first access request to the synchronization agent SA (S102). The type of the access request is, for example, a type (for example, OPEN, READ, or the like of a file) of an operation on the first file system FS1.

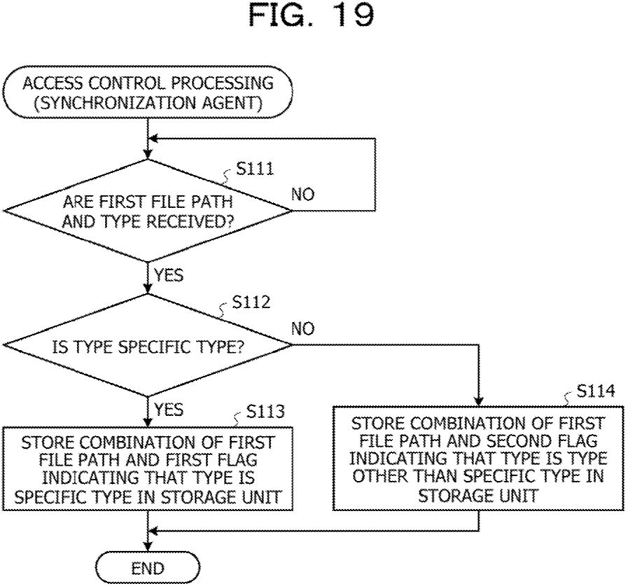

On the other hand, as illustrated in FIG. 19, for example, the synchronization agent SA waits until the first file path and the first type transmitted from the first file system FS1 are received (NO in S111).

For example, in a case where the first file path and the first type transmitted from the first file system FS1 are received (YES in S111), the synchronization agent SA refers to type information 132 stored in a partial area (hereinafter, also referred to as a second storage unit) of the information storage area 130, and determines whether the received first type is a type (hereinafter, also referred to as a specific type) stored as the type information 132 (S112). Hereinafter, a specific example of the type information 132 is described.

### Specific Example of Type Information

FIG. 22 is a diagram illustrating the specific example of the type information 132. For example, an “unlink” and a “flock” are set as an “operation” in the type information 132 illustrated in FIG. 22.

Returning to FIG. 19, when it is determined that the first type is the specific type (YES in S112), the synchronization agent SA stores, for example, a combination of the first file path of the first file FL corresponding to the first access request and a flag (hereinafter, also referred to as a first flag) indicating that the type is the specific type in the information storage area 130 as file path information 133 (S113).

By contrast, when it is determined that the first type is not the specific type (NO in S112), the synchronization agent SA stores, for example, a combination of the first file path of the first file FL corresponding to the first access request and a flag (hereinafter, also referred to as a second flag) indicating that the type is not the specific type in the information storage area 130 as the file path information 133 (S114). Hereinafter, a specific example of the file path information 133 is described.

### Specific Example of File Path Information

FIG. 23 is a diagram illustrating the specific example of the file path information 133. Hereinafter, the description will be given on the assumption that the first flag is “0” and the second flag is “1”.

For example, in the file path information 133 illustrated in FIG. 23, in information in a first line, “/aaa/bbb/ccc” is set as the “file path” and “0” is set as the “flag”.

For example, in the file path information 133 illustrated in FIG. 23, in information in a second line, “/aaa/bbb/ddd” is set as the “file path” and “1” is set as the “flag”. Description for the rest of the information included in FIG. 23 is omitted.

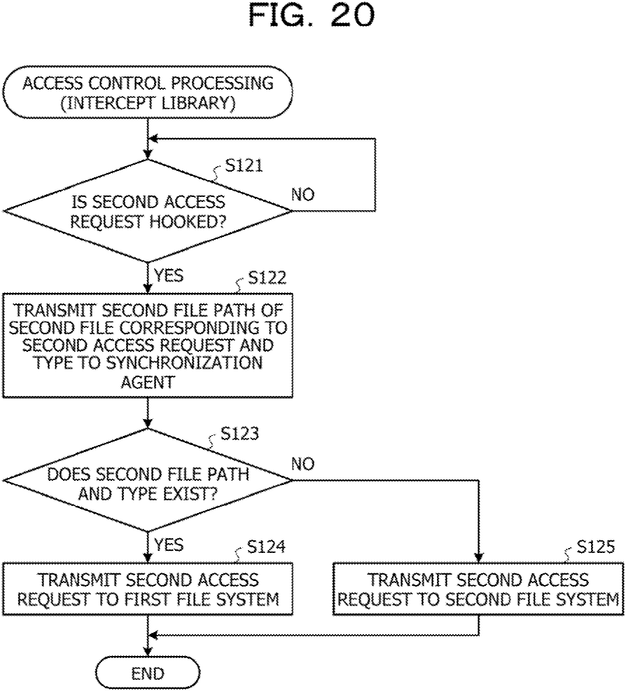

Returning to FIG. 20, for example, the intercept library IL waits until the intercept library IL hooks the second access request for the second file FL stored in the storage apparatus 2 (NO in S121).

For example, when the second access request for the second file FL stored in the storage apparatus 2 is hooked (YES in S121), the second file system FS2 transmits a second file path of the second file FL corresponding to the received second access request and a type (hereinafter, also referred to as a second type) of the access request corresponding to the received second access request to the synchronization agent SA (S122).

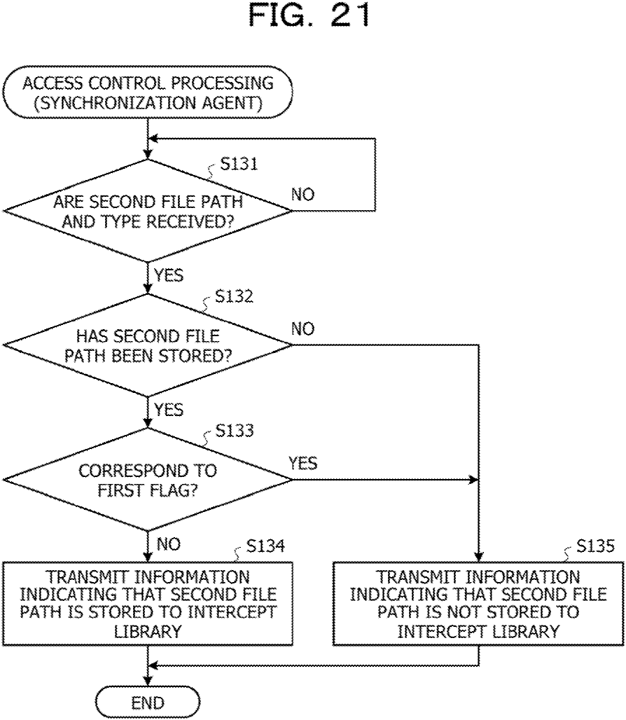

On the other hand, as illustrated in FIG. 21, for example, the synchronization agent SA waits until the second file path and the second type transmitted from the intercept library IL are received (NO in S131).

For example, when the second file path and the second type transmitted from the second file system FS2 are received (YES in S131), the synchronization agent SA determines whether the received second file path is stored in the information storage area 130 as the file path information 133 (S132).

As a result, when it is determined that the second file path is stored (YES in S132), for example, the synchronization agent SA determines whether the second file path determined to be stored corresponds to the first flag (S133).

For example, in the file path information 131 illustrated in FIG. 23, in the information in the first line, “/aaa/bbb/ccc” is set as the “file path” and “0” is set as the “flag”, for example. For this reason, when the second file path received in the processing of S131 is “/aaa/bbb/ccc”, the synchronization agent SA determines that the second file path corresponds to “0” indicating the first flag.

For example, when it is determined that the second file path corresponds to the first flag (YES in S133), the synchronization agent SA transmits information indicating that the second file path is stored in the information storage area 130 as the file path information 133 to the intercept library IL (S134).

For example, in this case, the synchronization agent SA determines that the access to the second file FL in the past has been performed through the first route and that it is not an access request corresponding to a type (specific type) for which the target second file FL is not stored in the cache CS, and performs control such that the transmission and reception of the second access request are performed through the first route, for example.

By contrast, when it is determined that the second file path is not stored in the information storage area 130 as the file path information 131 (NO in S132) or when it is determined that the second file path does not correspond to the first flag (NO in S133), the synchronization agent SA transmits, for example, information indicating that the second file path is stored in the information storage area 130 as the file path information 133 to the intercept library IL (S135).

For example, in this case, the synchronization agent SA determines that the access to the second file FL in the past has not been performed through the first route or that it is the access request corresponding to the type (specific type) for which the target second file FL is not stored in the cache CS, and performs control such that the transmission and reception of the second access request are performed through the second route, for example.

Returning to FIG. 20, for example, when the information indicating that the second file path is stored in the information storage area 130 as the file path information 131 is received from the synchronization agent SA (YES in S123), the intercept library IL transmits, for example, the hooked second access request to the first file system FS1 (S124). For example, the intercept library IL transmits the second access request to the virtual file system VFS.

By contrast, for example, when the information indicating that the second file path is not stored in the information storage area 130 as the file path information 131 is received from the synchronization agent SA (NO in S123), the intercept library IL transmits the hooked second access request to the second file system FS2 (S125).

### Access Control Processing According to Third Embodiment

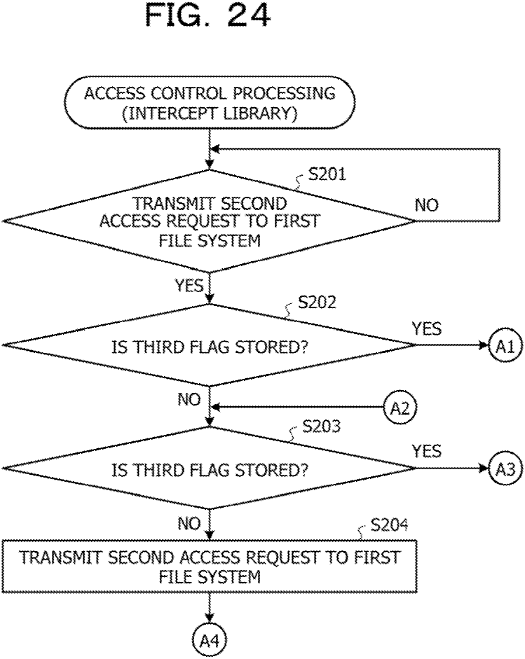

Next, access control processing in a third embodiment is described. FIGS. 24 to 26 are flowcharts illustrating the access control processing in the third embodiment. Among the access control processing in the third embodiment, the processing in the first file system FS1 and the synchronization agent SA is similar to the processing in the first embodiment and the second embodiment. For this reason, the processing in the intercept library IL, among the access control processing in the third embodiment, is described below.

For example, in the access control processing in the third embodiment, in a case where a time (hereinafter, also referred to as a response time T1) taken for an inquiry from the intercept library IL to the synchronization agent SA exceeds a threshold, control is performed such that transmission and reception of the second access request are performed through the first route without making an inquiry from the intercept library IL to the synchronization agent SA.

Accordingly, for example, in a case where a processing load of the synchronization agent SA increases, the information processing apparatus 1 may reduce the processing load of the synchronization agent SA, and may suppress the synchronization agent SA from being in a high load state.

For example, the intercept library IL waits until the second access request for the second file FL stored in the storage apparatus 2 is hooked (NO in S201).

For example, when the second access request for the second file FL stored in the storage apparatus 2 is received (YES in S201), the intercept library IL determines whether a current time is a measurement timing of the response time T1 (S202). The measurement timing of the response time T1 may be, for example, a timing (for example, a timing every several seconds) determined in advance by a user. For example, the measurement timing of the response time T1 may be a timing at which a difference between a previous measurement time of the response time T1 and the current time reaches a time determined in advance by the user.

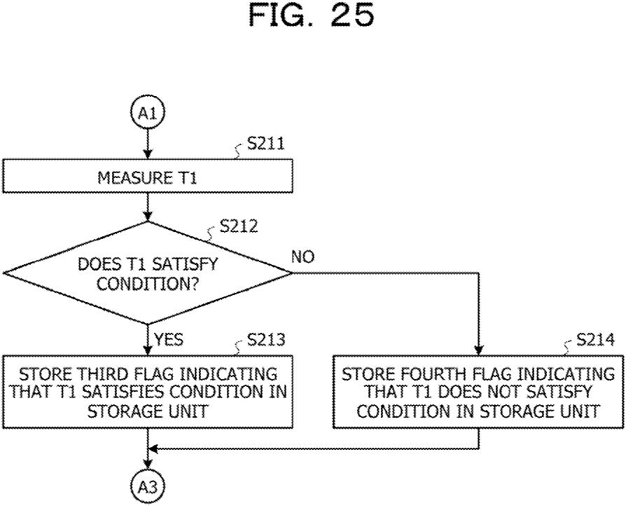

As a result, when it is determined that the current time is the measurement timing of the response time T1 (YES in S202), as illustrated in FIG. 25, the intercept library IL measures, for example, the response time T1 (S211).

Subsequently, the intercept library IL determines whether the measured response time T1 satisfies a predetermined condition, for example (S212).

For example, the intercept library IL measures a time (hereinafter, also referred to as a threshold time T2 or a predetermined time T2) taken in a case where the second access request is transmitted from the intercept library IL to the first file system FS1. For example, when it is determined that the response time T1 exceeds the threshold time T2, the intercept library IL determines that the response time T1 satisfies the predetermined condition.

As a result, when it is determined that the response time T1 satisfies the predetermined condition (YES in S212), the intercept library IL stores, for example, a flag (hereinafter, also referred to as a third flag) indicating that the response time T1 satisfies the predetermined condition in the information storage area 130.

By contrast, when it is determined that the response time T1 does not satisfy the predetermined condition (NO in S212), the intercept library IL stores, for example, a flag (hereinafter, also referred to as a fourth flag) indicating that the response time T1 does not satisfy the predetermined condition in the information storage area 130.

For example, when the response time T1 satisfies the predetermined condition, the intercept library IL determines that the processing load of the synchronization agent SA has increased. In this case, the intercept library IL stores, for example, the flag (fourth flag) indicating that the processing load of the synchronization agent SA has increased with respect to the flag stored in the information storage area 130 in the information storage area 130.

Returning to FIG. 24, in a case where it is determined that the current time is not the measurement timing of the response time T1 (NO in S202), after the processing in S213 or after the processing in S214, the intercept library IL determines whether the flag stored in the information storage area 130 is the third flag, for example.

As a result, when it is determined that the flag stored in the information storage area 130 is not the third flag, for example, when it is determined that the flag stored in the information storage area 130 is the fourth flag (NO in S203), the intercept library IL transmits, for example, the hooked second access request to the first file system FS1 (S204).

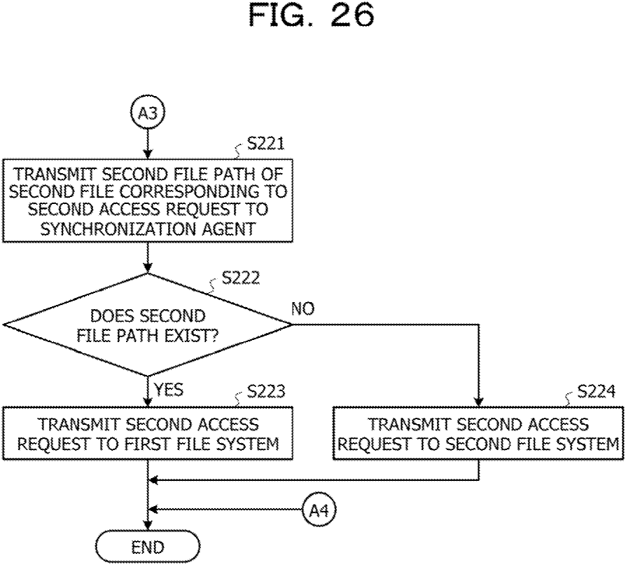

By contrast, when it is determined that the flag stored in the information storage area 130 is the third flag (YES in S203), as illustrated in FIG. 26, the intercept library IL transmits, for example, the second file path of the second file FL corresponding to the hooked second access request to the synchronization agent SA (S221).

For example, in this case, the intercept library IL determines that the processing load of the synchronization agent SA has not increased, and performs substantially the same processing as the access control processing in the first embodiment or the access control processing in the second embodiment.

Thereafter, for example, when the information indicating that the second file path is stored in the information storage area 130 as the file path information 131 is received from the synchronization agent SA (YES in S222), the intercept library IL transmits the hooked second access request to the first file system FS1 (S223). For example, the intercept library IL transmits the second access request to the virtual file system VFS.

By contrast, for example, when the information indicating that the second file path is not stored in the information storage area 130 as the file path information 131 is received from the synchronization agent SA (NO in S222), the intercept library IL transmits the hooked second access request to the second file system FS2 (S224).

The above embodiments are summarized as the following appendices.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising:
a memory configured to store a file; and
a processor including a first file system, a synchronization agent, an intercept library implemented in a user space and a virtual file system implemented in a kernel space and configured to control an access to the file stored in the memory,
wherein, in a case where a first access request for a first file stored in the memory is received in advance, the first file system transmits a first file path for the first file to the synchronization agent,
the synchronization agent stores the first file path received from the first file system in a first memory,
the intercept library transmits, in response to hooking a second access request for a second file stored in the memory this time, a second file path for the second file to the synchronization agent, and
the synchronization agent
determines whether the second file path is stored in the first memory, in response to reception of the second file path transmitted from the intercept library, and
performs control such that an access to the second file is performed by the first file system via the virtual file system in a case where it is determined that the second file path is stored in the first memory, and performs control such that the access to the second file is performed by the intercept library not via the virtual file system but via the second file system in a case where it is determined that the second file path is not stored in the first memory.

2. The information processing system according to claim 1,
wherein the first access request and the first file are transmitted and received through a cache of the virtual file system, and
the second access request and the second file are transmitted and received without passing through the cache of the virtual file system.

3. The information processing system according to claim 1,
wherein the intercept library transmits a type of the second access request to the synchronization agent in response to hooking the second access request, and
the synchronization agent
determines whether the type of the second access request is stored in a second memory in response to reception of the type of the second access request transmitted from the intercept library, and
performs control such that the access to the second file is performed by the first file system in a case where it is determined that the second file path is stored in the first memory and the type of the second access request is not stored in the second memory, and performs control such that the access to the second file is performed by the intercept library in a case where it is determined that the second file path is not stored in the first memory or the type of the second access request is stored in the second memory.

4. The information processing system according to claim 1,
wherein the intercept library
performs the access to the second file in response to receiving an instruction to access the second file from the synchronization agent, and
performs control such that an access to a new file is performed by the first file system in response to hooking an access request for the new file stored in the memory in a case where a time from transmission of the second file path to the synchronization agent to reception of the instruction is equal to or longer than a predetermined time.

5. The information processing system according to claim 4,
wherein the predetermined time is a time in a case where an access to a file stored in the memory is performed by the first file system.

6. An access control method comprising:
controlling, by a processor including a first file system, a synchronization agent, an intercept library implemented in a user space and a virtual file system implemented in a kernel space, an access to a file stored in a memory,
wherein, in a case where a first access request for a first file stored in the memory is received in advance, the first file system transmits a first file path for the first file to the synchronization agent,
the synchronization agent stores the first file path received from the first file system in a first memory,
the intercept library transmits, in response to hooking a second access request for a second file stored in the memory this time, a second file path for the second file to the synchronization agent, and
the synchronization agent
determines whether the second file path is stored in the first memory, in response to reception of the second file path transmitted from the intercept library, and
performs control such that an access to the second file is performed by the first file system via the virtual file system in a case where it is determined that the second file path is stored in the first memory, and performs control such that the access to the second file is performed by the intercept library not via the virtual file system but via the second file system in a case where it is determined that the second file path is not stored in the first memory.

7. The access control method according to claim 6,
wherein the first access request and the first file are transmitted and received through a cache of the virtual file system, and
the second access request and the second file are transmitted and received without passing through the cache of the virtual file system.

8. The access control method according to claim 6,
wherein the intercept library transmits a type of the second access request to the synchronization agent in response to hooking the second access request, and
the synchronization agent
determines whether the type of the second access request is stored in a second memory in response to reception of the type of the second access request transmitted from the intercept library, and
performs control such that the access to the second file is performed by the first file system in a case where it is determined that the second file path is stored in the first memory and the type of the second access request is not stored in the second memory, and performs control such that the access to the second file is performed by the intercept library in a case where it is determined that the second file path is not stored in the first memory or the type of the second access request is stored in the second memory.

9. The access control method according to claim 6,
wherein the intercept library
performs the access to the second file in response to receiving an instruction to access the second file from the synchronization agent, and
performs control such that an access to a new file is performed by the first file system in response to hooking an access request for the new file stored in the memory in a case where a time from transmission of the second file path to the synchronization agent to reception of the instruction is equal to or longer than a predetermined time.

10. The access control method according to claim 9,
wherein the predetermined time is a time in a case where an access to a file stored in the memory is performed by the first file system.
